(19) United States
(12) Patent Application Publication
(10) Pub. No.: US 2017/0245530 A1
(43) Pub. Date: Aug. 31, 2017

(54) METHOD AND SYSTEM FOR DEGASSING AND REINJECTION OF FOOD PRODUCT FLUIDS

(71) Applicant: SODETECH, LA TESTE DE BUCH (FR)

(72) Inventors: JEAN LARROCHE, LA TESTE DE BUCH (FR); BRIGITTE LARROCHE, PARIS (FR)

(21) Appl. No.: 15/442,647

(22) Filed: Feb. 25, 2017

(30) Foreign Application Priority Data
Feb. 25, 2016 (FR) 16 51544

(51) Int. Cl. A23L 5/30; A23L 3/015; A23L 3/36

(52) U.S. Cl. CPC A23L 5/30; A23L 3/36; A23L 3/015; A23V 2002/00

(57) ABSTRACT

Method and system to prepare and store untreated foods destined for processing and conservation packaging. The system eliminates bacteria from untreated or transformed foods, and includes a degasser, an injector to inject gas or liquid and a cooler. Degassing is carried out after the foods have been gathered together, cut, washed, and optionally treated to neutralize the enzymatic activity, then cooled, before the products are sterilized or pasteurized. The degassing is followed by reinjection of non-condensable neutral gas. During the reinjection of neutral gas which takes place in a liquid form, cooling is imposed on the degassed foods to the vaporization of the neutral gas projected into the enclosure where the foods are confined. All of the operations are directed to the elimination of the non-sporulated microorganisms, which limits the inoculum found in the products when they are stored.

### FIELD OF THE INVENTION

The present invention relates to the food industry, and more particularly to a process and a method for degassing of food products with reinjection of fluids.

The present invention relates more particularly to the techniques of preparation and storage of untreated foods which are destined for processing and conservation packaging, and represents a possibility for complete equipment for degassing, impregnating with gas or liquid, cooling and elimination of bacteria from untreated or transformed foods.

### PRIOR ART

Techniques for continuous degassing of foods have not been studied in depth because, hitherto, the packaging techniques have not made it possible to maintain a durable deep vacuum, thus making the initial degassing work useless. In order to obtain a durable deep vacuum in containers, it is necessary to take every opportunity to eliminate the non-condensable gases in the circuits of the machines throughout the processing, and in particular in the tissues of the foods treated.

The invention presented here relates to techniques for preparation and storage of untreated foods, irrespective of their animal or vegetable nature, which are destined for processing and subsequent conservation packaging, and in which it is wished to eliminate the oxygen durably, to an extent that it is possible to dispense with the conventional additives or other techniques which prevent rancidness in the food industry, such as ascorbic acid, the latter being just one example out of others.

The invention relates to a process and a system which represent a possibility of complete equipment for application of the initial degassing process and impregnation described in French patent no. FR 2 829 106 B1, or also which permit initial degassing of the foods as advocated in European patent no. EP 2 357 136 B1, submitted by the same inventors, or also which permit durable deoxygenation, elimination of bacteria, and immediate cooling or freezing of foods for storage whilst they are waiting for subsequent processing, without any risk of spoiling by oxidation.

All of the operations give rise to a first efficient elimination of the non-sporulated microorganisms, which limits the inoculum which will be found in the products at the moment when they are put into storage.

This storage can be carried out by temporary refrigeration under neutral gas, and can continue until freezing takes place.

### DISCLOSURE OF THE INVENTION

The present invention makes possible a continuous and successive process of degassing, elimination of bacteria and refrigeration or freezing of food products in pieces, and which is particularly advantageous for preparing in advance the industrial packaging of food products, whether these are frozen, refrigerated or conserved products, and whether they are conventional or under deep vacuum, since the degassing eliminates the risk of deterioration of the fatty substances, flavors and natural dyes for which the oxygen is responsible, thus avoiding having to use additives such as ascorbic acid.

The invention is particularly advantageous for the preparation of foods to be packaged under deep vacuum, since it makes it possible to increase further the level of vacuum in the final container, whilst preventing the resurgence of gas included in the tissues of the pieces of food or in the equipment, sauces or juices processed.

The invention is particularly advantageous for storage of fresh foods waiting for production processing which can be spread throughout the year, for example in cooked dishes.

The invention proposed makes possible a continuous process, which makes it compatible with the real situation of products output on industrial lines.

Hereinafter in this document, “product” or “products” means foods in general.

For this purpose, in its most generally accepted form, the present invention relates to a process which permits deoxygenation, elimination of bacteria and cooling or freezing of food products, comprising the following steps:
degassing of said food products; and
reinjection of fluids,
   said process being implemented by means of a system comprising three main elements, i.e. a degasser dₐ, a reinjector r_{b}, the longitudinal axial position of which can be oriented relative to the horizontal plane, such as to be able to provide it with a specific orientation, and a source sᵣ of impregnation fluid.

Advantageously, said degassing step comprises the following sub-steps:
a sub-step during which the degasser receives the product via a non-return input lock chamber equipped with a dosing mechanism, which lock chamber is situated at an end of the tube formed by said degasser;
a sub-step during which the product progresses in said degasser by means of an endless screw, the discs of which are perforated more finely than the pieces of food received;
a sub-step during which said degasser releases the product via a non-return output lock chamber equipped with a sealed dosing mechanism,
   said degasser being equipped with an adjustable vacuum pump which is powerful enough to be able to maintain an enclosure at an absolute pressure lower than 30 mbar, and if possible to be able to reach 10 mbar, with the result that, when the food product enters at ambient temperature, boiling takes place within the product which facilitates its degassing, which makes it possible to clear from any cavities which may be present in the foods any traces of non-condensable gas, in particular oxygen, and also makes it possible to explode the non-sporulated cells of the microorganisms present in the degasser, and finally makes it possible to give rise to a first cooling of said foods as a result of very light evaporation of part of the liquid water present in the foods.

Preferably, said reinjection step comprises the following sub-steps:
a sub-step during which the reinjector receives the product via the output lock chamber of the degasser situated at an end of the tube formed by said reinjector, which output lock chamber is connected to the reinjector;
a sub-step during which the reinjector receives an impregnation fluid via a mechanism of valves, and injector and control spouts, said impregnation fluid making it possible to fill efficiently the interstitial gaps and cavities in the foods,
   the distance between the output lock chamber of the degasser and the point of falling of the product into the reinjector being as short as possible, such that the immersion of the product in the impregnation fluid takes place as quickly as possible, and that the impregnation fluid can fill efficiently the interstitial gaps and cavities in the foods without non-condensable gases being able to enter into said gaps or cavities;
   said reinjection step then comprising the following sub-step:
a sub-step during which the product progresses in the reinjector by means of an endless screw, the discs of which are perforated more finely than the pieces of food received;
   the pressure which exists in the reinjector remaining equal to, or slightly greater than atmospheric pressure;
   said reinjection step then comprising the following sub-step:
a sub-step during which the reinjector releases the product via an outlet situated at the other end of the reinjector, via which outlet the products are discharged by gravity and open onto an area which is protected, for example by a plastic skirt, such that said products can fall into the recipient container without at any time being in contact with the air.

The present invention also relates to a system for implementation of the above described method, comprising a degasser dₐ, a reinjector r_{b}, the longitudinal axial position of which can be oriented relative to the horizontal plane, such as to be able to provide it with a specific orientation, and a source sᵣ of impregnation fluid.

Advantageously, said degasser is equipped with a mechanism to control the level of the food product along an endless screw, which makes it possible to regulate the flow of input of the products into said degasser.

According to one embodiment, said source of impregnation fluid is a pressurized container containing a neutral gas permitted in the food industry (nitrogen), the boiling point of which is cold enough, and the pressure of which is high enough so that, when the source is put into contact with the reinjector, the neutral gas vaporizes immediately when entering the reinjector, and penetrates deeply into the gaps and cavities in the pieces of food further to the sudden loss of the vacuum at the output of the degasser, thus preventing reoxygenation from taking place subsequently inside the products during temporary contact with the air, whilst also assisting rapid and homogenous cooling to the core of said pieces of food in order to obtain positive or negative cold conservation temperatures (freezing). In this embodiment, the product outlet is constituted by a lock chamber with cells which makes it possible to keep the reinjector pressurized with neutral gas.

Preferably, said reinjector comprises a control system including a thermostat which is coupled to a mechanism for regulation of the neutral gas injection flow which makes it possible to guarantee that the products are output at a constant target temperature which can reach the freezing temperature.

According to another embodiment, said source of impregnation fluid is a container containing a liquid of the seasoning type based on oil or water which has previously also been degassed, situated at the top so that the flow of liquid takes place naturally by gravity, or it is slightly pressurized so that, when the source is put into contact with the reinjector, said liquid flows into the reinjector in order to form a bath in which the foods can be soaked and easily impregnated with said liquid, which can thus penetrate deeply into the gaps and cavities in the pieces of food further to the sudden loss of the vacuum at the output from the degasser, thus preventing reoxygenation from taking place subsequently inside the products during temporary contact with the air, and it comprises means for inclining the enclosure, such that the outlet is situated above the level of the impregnation liquid, in order to prevent the liquid from escaping from the reinjector, and it additionally comprises a sub-system for permanent control and regulation of the injection flow of said liquid, which makes it possible to guarantee that the liquid is topped up, and that the impregnation liquid in the reinjector is kept at a constant level. According to the embodiment with liquid of the seasoning type, the reinjector is also equipped with means for injection of saturated steam in the vicinity of the input of the products output from the degasser tube, in order to prevent the foods from being re-impregnated with non-condensable gases before reaching the liquid; in this case, the addition of heat to the reinjector is compensated for by the cooling induced by the input of the products themselves, the degassing of which has induced cooling. In this embodiment, the product outlet is constituted by a simple hopper, at the level of which the products are protected against any contact with the air thanks to the saturated steam atmosphere which escapes from the reinjector, since the reinjector is kept at a pressure which is equal to, or slightly higher than, atmospheric pressure.

### BRIEF DESCRIPTION OF THE DRAWINGS

The invention will be better understood by means of the description provided hereinafter, purely by way of explanation, of an embodiment of the invention, with reference to the figures in which:

FIG. 1 represents the system for degassing, cooling and pre-sterilizing of food in pieces according to the present invention;

FIG. 2 illustrates the system for degassing and impregnation of foods in pieces according to the present invention; and

FIG. 3 represents the system for degassing and pre-sterilizing of foods in paste form with or without a piece/pieces according to the present invention.

### DETAILED DESCRIPTION OF EMBODIMENTS OF THE INVENTION

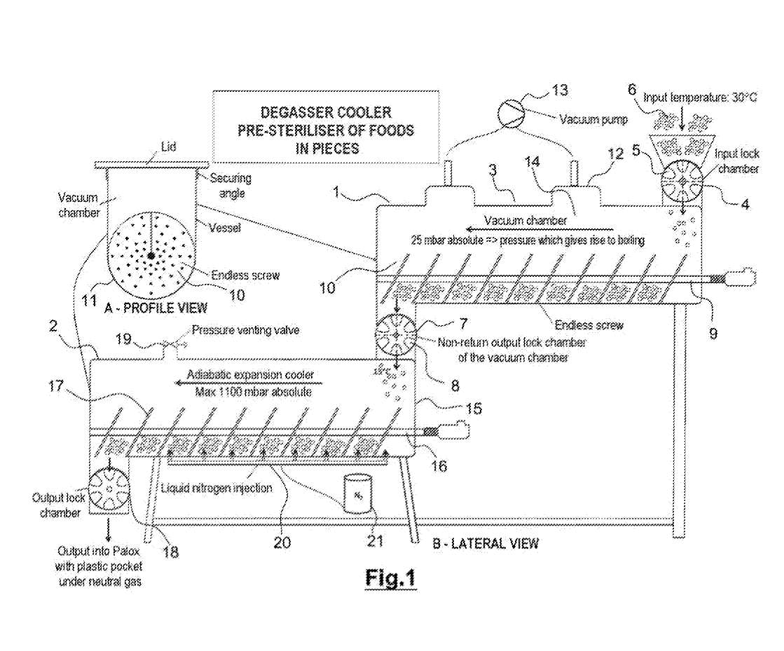

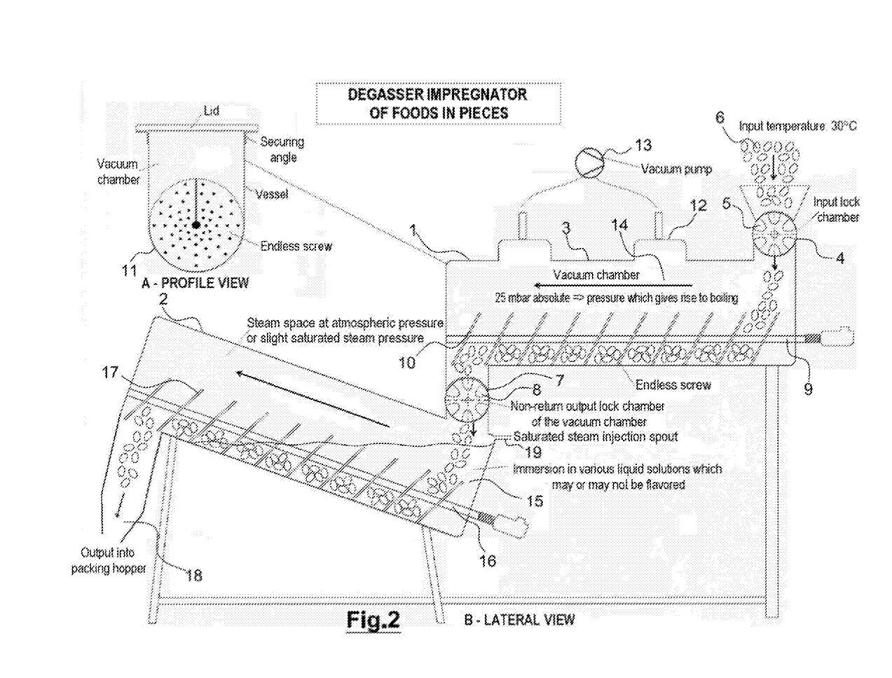

In a first configuration CONF 1 with two successive devices (degassing, impregnation) illustrated in FIGS. 1 and 2, the invention proposed permits operations of degassing and elimination of bacteria, which take place after the untreated foods have been gathered together, cut, washed, and optionally treated to neutralize the enzymatic activity in the foods, then cooled, but before impregnation, putting into storage and sterilization or pasteurization.

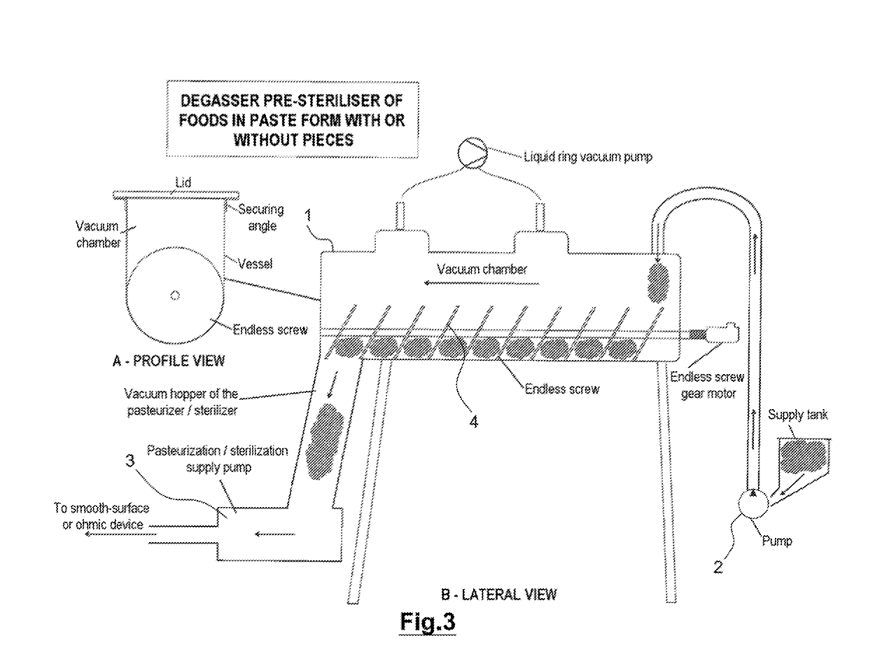

In another particular configuration illustrated in FIG. 3, the invention proposed makes it possible simply to degas and eliminate the bacteria from foods which have already been transformed of a paste type, with or without pieces, but without impregnating them, all before the products have been sterilized or pasteurized in a smooth-surface tube or in an ohmic tube.

Before the degassing by means of a vacuum pump, the foods are taken to an appropriate temperature, such that permanent light boiling at a low temperature takes place inside them, which facilitates the circulation of the non-condensable gases in the product, and permits very efficient degassing with continuous discharge of said gases by the vacuum pump.

This boiling by putting under sudden vacuum gives rise to explosion of the cytoplasms of the adult microbial cells. Only the dehydrated spores are not affected.

In a first variant of the configuration CONF 1 illustrated in FIG. 1, and which is suitable for subjection to neutral gas, this degassing can be followed by reinjection of neutral gas, such as dinitrogen (nitrogen) or carbon dioxide. During the reinjection of neutral gas which takes place in liquid form, cooling is imposed on the degassed foods further to the vaporization of the neutral gas projected into the enclosure where the foods are confined.

In another variant of the configuration CONF 1, illustrated in FIG. 2, the degassing can be followed by bubbling through in a liquid solution which is designed to impregnate the foods in order to replace any cavities inside the pieces of products, which, in a particular application, would optionally make it possible to refill them with oils or other particular types of seasoning.

In the particular application with injection of nitrogen gas described in the diagram in FIG. 1, said device comprises two successive enclosures 1 and 2, the first being a vacuum pump degasser, and the second being a neutral gas reinjection enclosure, these enclosures being separated from the exterior by non-return lock chambers which permit in succession the introduction of the foods, their passage from the first enclosure to the second, and their discharge into a pallock (for example made by Palox), i.e. a rigid container with a large size (for example 2.4 m³) provided with a plastic pocket which is hermetically sealed against gases and is provided with a closure device of the zip type which can be opened and re-closed in order to keep the products in a confined atmosphere saturated with neutral gas.

Said degasser comprises an elongate transfer tube 3, the base of which (cf. profile view A) is strictly semi-cylindrical, having a sealed input lock chamber 4 equipped with a device with cells 5 which make it possible to admit fixed quantities of product 6, and a sealed non-return output lock chamber 7 also equipped with a device with cells 8, making it possible to discharge fixed quantities of product after they have been degassed, without damaging the pieces.

Inside said tube 3, a motorized rotary shaft 9 is fitted in the axial direction, supporting an endless screw 10, the lateral ends of which are designed to reach almost to the inner surface of the base of the tube 11 which forms a half cylinder, and to make the product advance when the screw is in action. The spiral formed by the endless screw should preferably be perforated with holes with a dimension smaller than all the pieces of products to be treated (cf. extra small peas etc.), so as to prevent any liquids added from being driven to the output lock chamber.

Towards the middle of the tube, the wall of the tube supports two or more domes 12 connected to a powerful vacuum pump 13 (cf. of the liquid ring 60 m³/hour type) which can extract the non-condensable gases present.

In use, the tube is positioned horizontally and filled only partly, such as to provide a vacuum chamber 14 in the upper part of the tube 1, along which the gases can circulate and reach the domes 12, where the vacuum pump extracts said gases permanently and when necessary, in order to maintain a deep vacuum in the enclosure of the tube (for example 24 mbar of absolute pressure for a product temperature of 30° C.), which pressure is therefore low enough to give rise to low-temperature boiling of the water contained in the product and assist the internal degassing of the pieces of product.

The temperature at which the product is introduced into said degasser can be modulated as required to add an effect of inactivation of the enzymes of certain foods, in particular in the case of raw vegetables.

For example by imposing on the product a heating phase at a temperature of 60° C. upstream from the degasser, and better still, by combining this with putting it under high pressure, it is possible to obtain accelerated inactivation of the vegetable enzymes. In a variant, it is also possible to decide to introduce the product when still hot (for example 60° C.) into the degasser, which would make the degassing induced by putting the product under deep vacuum more violent, this violence being able to be modulated by intermediate cooling between the treatment of inactivation of the enzymes and the entry into the degasser, the objective being to select appropriate parameters to obtain the effects required without damaging the products.

The boiling of the product in the degasser is accompanied by cooling of said foods further to the evaporation of part of the liquid water present in the foods, which, as is known, requires approximately 542 Kcal/gram of evaporated water. By way of illustration, a product which enters the tube at 25-30° C. must be able to reach 15° C. at the output from the degasser.

Said second enclosure 2 comprises an elongate transfer tube 15, the base of which (cf. profile view A) is strictly semi-cylindrical, and the input of which is formed by the output lock chamber 7 of the first enclosure 1.

Inside said tube 15, a motorized rotary shaft 16 is fitted in the axial direction, supporting an endless screw 17, the lateral ends of which are designed such as to reach almost to the inner surface of the base of the tube 15 which forms a half cylinder, and to make the product advance when the screw is in action. The spiral formed by the endless screw should preferably be perforated with holes with a dimension smaller than all the pieces of products to be treated (cf. extra small peas, etc.), so as to prevent any liquids added from being driven to the output lock chamber 18.

This enclosure 2 is known here as the reinjector for convenience of language.

First Variant of the System of Devices in the Configuration CONF 1, Illustrated in FIG. 1

Downstream from the degasser, a first variant of the reinjector makes it possible to subject the products to neutral gas. In this variant, towards the middle of the tube, the wall of the tube must support a pressure venting valve 19.

In the lower part of the enclosure 2, the pressure of which is kept slightly above atmospheric pressure, for example at 1100 mbar, such as to keep said enclosure 2 at a pressure slightly in excess of that of the atmosphere, and at a pressure which is greatly in excess of that of the enclosure 1, a series of spouts 20 makes it possible to inject the neutral gas, which, by passing between the pieces of food and under the effect of the loss of the vacuum of the first enclosure 1, occupies any cavities left empty in the foods by the degasser (enclosure 1).

Said neutral gas is obtained from a source of pressure 21 which is far greater than that in the enclosure 2. The injection of neutral gas is thus then accompanied by adiabatic expansion which gives rise to significant cooling of the foods through which it passes.

In use, the tube is positioned horizontally or slightly inclined, such that the products can progress without impediment.

In the case of this first variant, the output lock chamber of the reinjector 18 is a sealed lock chamber equipped with a dosing mechanism, like the other lock chambers of the system of devices.

The pressures, temperature and injection flows of the nitrogen must be regulated according to the flows of circulation of the foods, the ambient temperature, the temperature of the foods introduced, and the final temperature required.

In a particular application of the present invention, by regulating flows and outputs appropriately, it is possible to obtain a product frozen using nitrogen, which protects the frozen product completely against any form of oxidation, and makes it possible to dispense with conventional additives such as ascorbic acid.

Second Variant of the System of Devices in the Configuration CONF 1, Illustrated in FIG. 2

In a second variant of the reinjector, the degassing can be followed by bubbling through in an impregnation liquid solution which is designed to replace any cavities inside the pieces of products, which bubbling through would take place in the enclosure 2.

The injection of said solution would then need to be organized such that, not only does the level of liquid reach permanently a height in the tube 15 which is sufficient for all the product to be able to be impregnated with liquid, but also for the fall of the products from the enclosure 1 into the impregnation liquid bath of the enclosure 2 to be as short as possible, in order for the cavities in the product to be filled as a matter of priority with the impregnation liquid, and not with something else.

In this second variant of the system of devices:
the reinjector must be able to be oriented with a slight slope which is designed to force the re-impregnation liquid to remain in the enclosure 2, and not to flow through the output lock chamber 18, which, in the case of this second variant does not need to be a lock chamber with cells, and can be a simple outlet;
the source of neutral gas 21 is unnecessary, and must be replaced by a source of impregnation liquid to be positioned above the level of the liquid required in the reinjector in order to permit the flow of the liquid;
the reinjector must be equipped with a mechanism for dosing and measuring the level of impregnation liquid;
the reinjector must be able to be oriented with a slight slope which is designed to prevent said re-impregnation liquid from escaping from the enclosure;
the atmosphere of the enclosure 2 is under atmospheric pressure or under slight pressure, and a saturated steam atmosphere is injected via the spout 19 in order to protect the products against the risk of re-integration of non-condensable gases during the time that they are falling into the liquid.

At the Output from the Reinjector, Irrespective of the Variant:

At the output from the reinjector, i.e. the enclosure 2, the products can fall into a container of the pallock type provided with a plastic bag which is impermeable to the gases.

The choice of the neutral gas is to be determined according to the advantages and disadvantages which the gases have for the foods concerned, and maintenance obligations, for example:
Acidification by the carbon dioxide versus density and stability of the carbon dioxide which falls to the bottom of the bags and does not exit from them.
Neutrality of the dinitrogen (nitrogen) versus escape of the dinitrogen to the top of the bag, thus requiring regular reinjection of gas.

Use of the System of Devices in the Configuration CONF 2

In the configuration CONF 2, which is used for the initial degassing and pre-sterilization of products in paste form, with or without pieces, before heat treatment, as proposed in a preferred form in FIG. 3:
the enclosure 1 alone is used and modified as follows:
the input lock chamber with cells 4 in FIG. 1 is replaced by a supply pump of the enclosure 2 in FIG. 3;
the output lock chamber 7 in FIG. 1 is eliminated and replaced by a hopper followed by a supply pump 3 in FIG. 3, in order to supply the heat treatment tube (smooth surface or ohmic);
the discs of the endless screw described at 11 in FIG. 1 are not provided with holes in configuration 2 (see 4 in FIG. 3).

1-8. (canceled)

9. A method for deoxygenating, eliminating bacteria and cooling or freezing of food products, comprising steps of:
degassing of the food products by a degasser;
injection of an impregnation fluid by an injector from a source of the impregnation fluid; and
orienting a longitudinal axial position of the injector relative to a horizontal plane to provide a specific orientation, the system comprising the degasser, the injector and the source.

10. The method as claimed in claim 9, wherein the degassing step comprises steps of:
receiving the food products by the degasser via a non-return input lock chamber equipped with a dosing mechanism, the non-return input lock chamber being situated at an end of a tube formed by the degasser;
progressing the food products in the degasser by an endless screw comprising discs, the discs are perforated more finely than pieces of the received food products;
releasing the food products by the degasser via a non-return output lock chamber equipped with a sealed dosing mechanism; and
maintaining an enclosure at an absolute pressure lower than 30 mbar by an adjustable vacuum pump of the degasser such that the food products enter the enclosure at an ambient temperature and boiling takes place within the food products which facilitates degassing of the food products.

11. The method as claimed in claim 10, wherein the degassing of the food products facilitates clearing traces of non-condensable gas from cavities in the food products.

12. The method as claims in claim 11, wherein the degassing of the food products facilitates clearing traces of oxygen.

13. The method as claim in claim 10, wherein the degassing of the food products facilitates explosion of non-sporulated cells of microorganisms present in the degasser.

14. The method as claimed in claim 10, wherein the degassing of the food products facilitates a first cooling of the food products as a result of an evaporation of a part of a liquid water present in the food products.

15. The method as claimed in claim 10, wherein the enclosure is substantially maintained at the absolute pressure of 10 mbar by the adjustable vacuum pump of the degasser.

16. The method as claimed in claim 10, wherein the reinjection step comprises steps of:
receiving the food products by the injector via the non-return output lock chamber of the degasser situated at an end of the tube formed by the injector, the non-return output lock chamber being connected to the injector;
receiving the impregnation fluid by the injector via valves and control spouts to fill interstitial gaps and cavities in the food products, a distance between the non-return output lock chamber of the degasser and the injector is minimized to facilitate a rapid immersion of the food products in the impregnation fluid and to efficiently fill the interstitial gaps and cavities in the food products with the impregnation fluid without reintroducing non-condensable gases into the interstitial gaps or cavities;
progressing the food products in the injector by an endless screw comprising discs, the discs are perforated more finely than pieces of the received food products, a pressure in the injector is equal to or slightly greater than an atmospheric pressure; and
releasing the food products by the injector via an outlet situated at other end of the injector and discharging the food products by gravity via the outlet to a hopper which limits a contact of the food products with the air to prevent reinfection by spores and re-oxygenation of the food products.

17. A system to implement the method of claim 9, comprising a source of an impregnation fluid, a degasser to degas food products; and an injector to inject the impregnation fluid from the source of the impregnation fluid, a longitudinal axial position of the injector is orientable relative to a horizontal plane to provide a specific orientation.

18. The system as claimed in claim 17, wherein the degasser comprises an endless screw and a controller to control a level of the food products along the endless screw to regulate a flow of the food products inputted into the degasser.

19. The system as claimed in claim 17, wherein the source of impregnation fluid is a pressurized container containing a neutral gas for use in a food industry; wherein a boiling point of the neutral gas is sufficiently cold and a pressure of the neutral gas is sufficiently high such that the neutral gas vaporizes upon contact with the injector; and wherein the neutral gas penetrates deeply into interstitial gaps and cavities in pieces of the food products as a result of a sudden loss of a vacuum at an output of the degasser, thereby preventing occurrence of re-oxygenation inside the food products during a temporary contact with the air while facilitating a rapid and homogenous cooling to a core of the pieces of the food products to obtain positive or negative cold conservation temperatures.

20. The system as claimed in claim 19, wherein the injector comprises a controller, the controller comprising at least a thermostat which is coupled to a regulator to regulate an injection flow of the neutral gas to output the food products at a constant target temperature which can reach a freezing temperature.

21. The system as claimed in claim 17, wherein the source of impregnation fluid is a container containing a liquid of a seasoning type based on oil or water which has previously been degassed, the source is situated at top of the injector such that the liquid flows naturally by gravity, or the liquid is pressurized such that the liquid flows into the injector when the source is placed in contact with the injector, to form a bath in which the food products are soaked and impregnated with the liquid; and wherein the liquid penetrates deeply into interstitial gaps and cavities in pieces of food products as a result of a sudden loss of a vacuum at an output of the degasser, thereby preventing occurrence of re-oxygenation inside the food products during a temporary contact with the air.

22. The system as claimed in claim 21, further comprising an enclosure having an outlet and an incliner to incline the enclosure, the outlet being situated above a level of the impregnation liquid to prevent the impregnation liquid from escaping from the injector.

23. The system as claimed in claim 22, further comprising a controller to control and regulate an injection flow of the impregnation liquid to maintain the impregnation liquid in the injector at a constant level.

24. The system as claimed in claim 23, wherein the injector comprises a steam injector to inject a saturated steam in a vicinity of an inlet receiving the food products outputted from the degasser, to prevent the food products from being re-impregnated with non-condensable gases before being soaked and impregnated with the liquid
